(19) United States
(12) Patent Application Publication
(10) Pub. No.: US 2014/0263748 A1
(43) Pub. Date: Sep. 18, 2014

(54) ATOMIZING NOZZLE WITH IMPROVED ROTOR STRUCTURE

(71) Applicant: Hui San HSU, Taichung City (TW)

(72) Inventor: Hui San HSU, Taichung City (TW)

(21) Appl. No.: 13/832,391

(22) Filed: Mar. 15, 2013

(51) Int. Cl. B05B 7/04

(52) U.S. Cl. CPC B05B 7/0483
USPC 239/403

(57) ABSTRACT

An atomizing nozzle includes a combination of a body and a rotor. One end of the body has an inlet, and the other end of the body has a jetting hole. A channel passage connects the inlet to the jetting hole, and the rotor is mounted in the channel passage. The rotor has a head part and a body part, and at least one air passage is formed on a surface of the body part of the rotor. The air passage of the rotor surface may communicate with the channel passage. Thus, the fluid entering the channel passage may pass through the air passage and be jetted from the jetting hole to form a micro-atomization state, and the rotor is free from generating the obvious raked state or lateral displacement so that the working stability of the atomizing nozzle can be enhanced.

### BACKGROUND OF THE INVENTION

1. Field of the Invention

The invention relates to the technical field of micro-atomizing a liquid, and more particularly to an atomizing nozzle.

2. Related Art

A typical atomizing nozzle has a body and a rotor assembled in a channel inside the body. When the liquid enters the body and passes through a gap between the rotor and the channel, the liquid may be jetted from a jetting hole on one end of the body to form the micro-atomization state.

In order to make the liquid pass the gap between the rotor and the channel sufficiently and uniformly, the rotor may be manufactured to have the smaller outer diameter so that the gap between the rotor and the channel may be enlarged. However, enlarging the gap between the channel and the rotor causes the rotor to generate the raked state or lateral displacement in the channel, so that the rotor is in the incorrectly positioned state to cause the unstable atomizing effect. More particularly, the rotor is pushed with one single side attached to a certain wall surface of the channel, so that the liquid cannot uniformly pass through the periphery of the rotor and the liquid cannot generate the uniform micro-atomization smoothly.

### SUMMARY OF THE INVENTION

An object of the invention is to provide an atomizing nozzle with an improved rotor structure, which is free from generating the obvious raked state or lateral displacement, and can make the liquid pass through the periphery of the rotor sufficiently and uniformly, thereby enhancing the micro-atomization effect of the liquid.

To achieve the above-identified object and effect, the invention provides an atomizing nozzle including a combination of a body and a rotor, wherein one end of the body has an inlet, the other end of the body has a jetting hole, a channel passage connects the inlet to the jetting hole, and the rotor is mounted in the channel passage. The rotor has a head part and a body part, and at least one air passage is formed on a surface of the body part of the rotor. The air passage on the surface of the rotor may communicate with the channel passage. Thus, the fluid entering the channel passage may pass through the air passage and be jetted from the jetting hole to form a micro-atomization state.

The body part of the rotor may have a plurality of convex structures and a plurality of concave structures, wherein each concave structure is disposed between the neighboring convex structures, and each concave structure forms the air passage. When the rotor is accommodated within the channel passage, the convex structure may directly contact with an inner wall surface of the channel passage.

Also, the body part of the rotor may have a thread structure including a convex portion and a concave portion. The concave portion forms the air passage. When the rotor is accommodated within the channel passage, the convex structure may directly contact with the inner wall surface of the channel passage.

In addition, the body part of the rotor may have a plurality of projections. A gap is formed between the neighboring projections to form a channel. The channels communicate with each other or one another to form the air passage. When the rotor is accommodated within the channel passage, the projection may directly contact with the inner wall surface of the channel passage.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is an exploded view showing the invention.

FIG. 2 is a schematically assembled view of the invention.

FIG. 3 is a schematic illustration showing an arrangement of a rotor and a channel passage of the invention.

FIG. 4 is a schematic illustration showing a used state of the invention.

FIG. 5 shows a surface of a rotor according to another embodiment of the invention.

FIG. 6 shows a surface of a rotor according to still another embodiment of the invention.

### DETAILED DESCRIPTION OF THE INVENTION

The present invention will be apparent from the following detailed description, which proceeds with reference to the accompanying drawings, wherein the same references relate to the same elements.

Referring to FIG. 1, the atomizing nozzle has a body (10), a rotor (30) and a liquid stopping assembly (40). In detail, the body (10) is composed of a first member (12) and a second member (14) combined with each other. However, the structure of the body (10) is one of possible structures, and the invention is not restricted thereto.

The rotor (30) and the liquid stopping assembly (40) are mounted inside the body (10) in an axial direction in order.

Referring to FIG. 2, one axial end of the first member (12) of the body (10) has an inlet (16), and the inside of the first member (12) has an input channel (18) and a first accommodating channel (20) in an axial direction. The input channel (18) has one end connected to the inlet (16), and the other end connected to the first accommodating channel (20).

The inner diameter of the input channel (18) is smaller than an inner diameter of the first accommodating channel (20) so that a stopping edge (22) is formed at the connection position between the input channel (18) and the first accommodating channel (20).

An end surface of the second member (14) of the body (10) has a penetrating jetting hole (24), and the inside of the second member (14) has a second accommodating channel (26) disposed in an axial direction. The second accommodating channel (26) communicates with the jetting hole (24).

The first member (12) is combined with the second member (14) so that the input channel (18), the first accommodating channel (20) and the second accommodating channel (26) communicate with each other to form a channel passage (28).

As shown in FIGS. 1 and 2, the rotor (30) and the liquid stopping assembly (40) are mounted inside the channel passage (28). The rotor (30) includes a head part (32) and a body part (34), and the head part (32) is disposed on one end of the body part (34). In addition, the other end of the body part (34) is further extended to form a connecting column (36).

Furthermore, the outer diameters of the head part (32) and the connecting column (36) are smaller than the outer diameter of the body part (34). In addition, the surface of the body part (34) has a plurality of convex structures (38). The convex structures (38) are parallel to each other or one another and correspond to the axial direction of the body part (34). In addition, a concave structure (39) is formed between neighboring two of the convex structures (38). In other words, the surface of the body part (34) of the rotor (30) has a plurality of convex structures (38) and concave structures (39).

The liquid stopping assembly (40) includes a spring (42) and a liquid stopping plug (44). The combination of the spring (42) and the liquid stopping plug (44) is mounted in the body (10), wherein the spring (42) may rest against or be combined with the connecting column (36), and the liquid stopping plug (44) may receive the acting force of the spring (42) and rest against the stopping edge (22).

As shown in FIG. 3, it is to be noted that when the rotor (30) is mounted in the channel passage (28), the convex structure (38) of the surface of the rotor (30) may directly contact with the inner wall surface of the channel passage (28), so that the rotor (30) is free from generating the obvious raked state or lateral displacement in the channel passage (28). In addition, the fluid can pass through the gap between the concave structure (39) and the inner wall surface of the channel passage (28).

As shown in FIG. 4, when the fluid enters the input channel (18) from the inlet (16), it can push the liquid stopping plug (44) away from the stopping edge (22), so that the fluid can enter the first accommodating channel (20). Because the rotor (30) is stably mounted in the channel passage (28) and the rotor (30) cannot generate the obvious raked state or lateral displacement with the flowing of the fluid, the operating stability of the atomizing nozzle or micro-atomization system can be enhanced.

Referring again to FIG. 3, the design concept of the invention is to form at least one air passage (50), through which the fluid can pass smoothly, on the surface of the rotor (30), and this is different from the smooth structure on the surface of the conventional rotor. In addition, the outer surface of the rotor (30) of the invention may be possibly close to the inner wall surface of the channel passage (28), so that the raked state or lateral displacement generated upon the operation of the rotor (30) can be reduced, and the stability of the rotor (30) can be enhanced. According to the concept of the invention, the rotor (30) may further include the structures shown in the following embodiments.

Referring to FIG. 5, the surface of the rotor (30) may have a thread structure (52), which has a convex portion (54) and a concave portion (56). The concave portion (56) is constituted by the pitch of the thread structure (52), and the concave portion (56) may form the air passage (50) communicating with the channel passage (28). The thread structure (52) may be a single-thread structure or a dual-thread structure.

Referring to FIG. 6, still another embodiment of the invention is to form a plurality of projections (58) on the surface of the rotor (30), and the gap between the neighboring projections (58) may form the channel (60). It is to be noted that the channels (60) communicate with each other or one another and form the air passage (50). Two ends of the air passage (50) communicate with the channel passage (28), and the projection (58) on the surface of the rotor (30) may be close to or in direct contact with the inner wall surface of the channel passage (28). The combination of the projections (58) and the channels (60) may be formed by way of surface texturing or embossing.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An atomizing nozzle for atomizing a fluid, the atomizing nozzle comprising:
a body having one end having an inlet, and the other end having a jetting hole, wherein a channel passage connects the inlet to the jetting hole;
a rotor, which is mounted in the channel passage and has a body part and a head part connected to the body part; and
an air passage, which is formed on a surface of the body part of the rotor and communicates with the channel passage;
wherein the fluid enters the channel passage from the inlet, and thus passes through the air passage and is jetted from the jetting hole to form a micro-atomization state.

2. The atomizing nozzle according to claim 1, wherein the surface of the body part of the rotor has a plurality of convex structures and a plurality of concave structures, wherein the convex structures are parallel to each other or one another and located in an axial direction of the body part, an outer edge of each of the convex structures may directly contact with a wall surface of the channel passage, wherein each of concave structures is formed between neighboring two of the convex structures, and each of the concave structures may be parallel to the convex structure and form the air passage.

3. The atomizing nozzle according to claim 1, wherein the surface of the body part of the rotor has a plurality of projections, a gap is formed between neighboring two of the projections to form a channel, and the channels communicate with each other or one another to form the air passage.

4. The atomizing nozzle according to claim 1, wherein the surface of the body part of the rotor has a thread structure, the thread structure has convex portions and concave portions, the convex portions directly contact with a wall surface of the channel passage, and the concave portion forms the air passage.

5. The atomizing nozzle according to claim 1, further comprising a liquid stopping assembly, which is mounted in the channel passage, and located between the body part of the rotor and the inlet of the body.

6. The atomizing nozzle according to claim 5, wherein one end of the body part of the rotor is further extended to form a connecting column to be combined with the liquid stopping assembly.

7. The atomizing nozzle according to claim 2, further comprising a liquid stopping assembly, which is mounted in the channel passage and located between the body part of the rotor and the inlet of the body, wherein one end of the body part of the rotor is further extended to form a connecting column to be combined with the liquid stopping assembly.

8. The atomizing nozzle according to claim 3, further comprising a liquid stopping assembly, which is mounted in the channel passage and located between the body part of the rotor and the inlet of the body, wherein one end of the body part of the rotor is further extended to form a connecting column to be combined with the liquid stopping assembly.

9. The atomizing nozzle according to claim 4, further comprising a liquid stopping assembly, which is mounted in the channel passage and located between the body part of the rotor and the inlet of the body, wherein one end of the body part of the rotor is further extended to form a connecting column to be combined with the liquid stopping assembly.

10. The atomizing nozzle according to claim 5, wherein the liquid stopping assembly comprises a spring and a liquid stopping plug, the spring is to be connected to the rotor, and the liquid stopping plug corresponds to the inlet.
